(19) United States
(12) Patent Application Publication
(10) Pub. No.: US 2010/0305291 A1
(43) Pub. Date: Dec. 2, 2010

(54) Non-Fouling Receptor Labeled Multi-Functional Surfaces

(75) Inventors: Richard B. Timmons, Arlington, TX (US); Dattatray S. Wavhal, Maharashtra (IN); Rupert Anthony Taylor, Austin, TX (US); Breca Starr Tracy, Dripping Springs, TX (US); Donald E. Owens, III, Austin, TX (US); Rachel Kennedy Khorzad, Austin, TX (US)

Correspondence Address: CHALKER FLORES, LLP, 2711 LBJ FRWY, Suite 1036, DALLAS, TX, 75234, US

(73) Assignees: Board of Regents, The University of Texas System, Austin, TX (US); AeonClad Coatings, LLC, Austin, TX (US)

(21) Appl. No.: 12/791,848

(22) Filed: Jun. 1, 2010

Related U.S. Application Data
(60) Provisional application No. 61/183,024, filed on Jun. 1, 2009.

(51) Int. Cl. C08J 7/18; C08F 20/06; C08F 20/14

(52) U.S. Cl. 526/317.1; 427/488; 526/329.7

(57) ABSTRACT

The present invention provides compositions and methods of forming a multifunctional polymer film by plasma discharge by providing one or more monomers to a plasma discharge reactor, wherein the one or more monomers comprising one or more functional groups; polymerizing the one or more monomers into a multifunctional polymer; and forming a polymer film from the multifunctional polymer on a surface.

### CROSS-REFERENCE TO RELATED APPLICATIONS

This application claims priority to U.S. Provisional Application Ser. No. 61/183,024, filed Jun. 1, 2009, the contents of which is incorporated by reference herein in its entirety.

### TECHNICAL FIELD OF THE INVENTION

The present invention relates in general to the fabrication multi-functional surfaces, specifically to compositions of matter and methods of making and fabrication of materials with multi-functional surfaces synthesized by a gas phase plasma enhanced chemical vapor deposition processes (PECVD).

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Without limiting the scope of the invention, its background relates in general to the fabrication multi-functional surfaces, specifically to compositions of matter and methods of making and fabrication of materials with multi-functional surfaces synthesized by a gas phase plasma enhanced chemical vapor deposition processes (PECVD).

Reduction of biomolecule surface adsorption represents a serious limiting factor in dictating ultimate detection sensitivities available in many sensor applications. Additionally, these adsorptions are generally undesirable in tissue culture studies involving use of specific ligands to elicit cellular responses on surfaces, as well as in vivo applications involving inflammatory response to implants. With respect to eliminating or, at least, minimizing this ubiquitous problem, a number of approaches have been developed to try to circumvent problems created by non-specific biomolecule adsorptions in systems employed in a wide variety of applications. Recent examples of attempts to minimize non-specific adsorptions include studies involving creation of interfacial architectures combined with detection methods such as surface plasmon resonance (SPR) and surface acoustical wave spectroscopies;^{[1,2,3]} self-assembled layers incorporating poly(ethylene glycol) with quartz crystal microbalance detection;^{[4]} SPR studies to detect label free insulin at very low concentrations;^{[5]} development of an unique buffer system to minimize non-specific bovine protein leptin binding, as examined by SPR.^{[6]}. The continued high level of activity in this area is a strong testament of the need for non-fouling surfaces while, at the same time, permitting surface attachment of desired compounds. A recent paper provides an overview of the scope of some of the prior work involving this important topic.^{[7]}

### SUMMARY OF THE INVENTION

The present invention also includes a multifunctional polymer film formed by plasma discharge a multifunctional polymer deposited on a substrate, wherein the multifunctional polymer comprises one or more monomers having one or more reactive functional groups for the subsequent attachment of targeted molecules that reduces adsorptions and provides controllable surface densities of reactive surface entities that attach to receptor molecules. The one or more reactive functional groups contributing the non-fouling properties to the polymer film and include ethylene oxide linkages, di-ethylene glycol vinyl, tri-ethylene glycol vinyl, allyl ethers and/or crown ethers, one or more reactive functional groups comprising —COOH, —NH₂, —CNO, C—Br, —SH, —CClO, —OH, —CHO, —C═O, anhydrides and one or more unsaturated bonds, and one or more unsaturated double bonds.

The present invention provides a process of forming a multifunctional polymer film by plasma discharge by providing one or more monomers to a plasma discharge reactor, wherein the one or more monomers comprising one or more reactive functional groups for the subsequent attachment of targeted molecules; polymerizing the one or more monomers into a multifunctional polymer; forming a polymer film from the multifunctional polymer on a surface that reduces adsorptions and provides controllable surface densities of reactive surface entities that attach to receptor molecules. The present invention also provides controlled release of coating, reducing adsorption, non-fouling, moisture resistance, attaching receptor molecules, active group on surface, preventing or controlling movement through media, increased bioavailability, and modifying active-agent release.

The present invention describes a relatively simple, new approach to minimizing non-specific biomolecule adsorptions but, at the same time, provide surfaces, which can be further labeled for specific applications. It centers on construction of a bifunctional surface containing both non-fouling properties while, simultaneously, providing reactive surface sites for attachment of specific target (e.g. receptor) molecules. For this purpose, a gas phase pulsed plasma enhanced chemical vapor deposition (PECVD) process, involving the simultaneous polymerization of two monomers, was employed. As an example of this bifunctional surface, the present invention describes use of a monomer containing ethylene oxide units to provide the non-fouling function, coupled with the use of a carboxylic acid containing monomer to provide the second chemically reactive functionality involving which can be used to attach targeted molecules. The efficacy of this new approach is demonstrated via variably controlled attachment of a fluorescently labeled biomolecule, with its extent of attachment precisely dictated by the ratio of non-fouling and reactive surface group densities introduced by the pulsed plasma CVD process.

### BRIEF DESCRIPTION OF THE DRAWINGS

For a more complete understanding of the features and advantages of the present invention, reference is now made to the detailed description of the invention along with the accompanying figures and in which:

FIGS. 1A-1E are graphs of a high resolution C(1s) XPS spectra for films EO2V (FIG. 1A), E/V1 (FIG. 1B), E/V2 (FIG. 1C), E/V3 (FIG. 1D) and VAA (FIG. 1E).

FIG. 2 is a is a graph of the FTIR spectra for films EO2V, E/V1, E/V2, E/V3 and VAA.

FIG. 3 is a graph of the contact angle for films EO2V, E/V1, E/V2, E/V3 and VAA.

FIG. 4 is a graph of the relative fluorescence intensity of the bifunctional surfaces having progressively higher EO content in reading from left to right.

FIG. 5 is a graph of the FTIR testing (Fluoropolymer only) of this same coating program applied to a silicon test wafer.

FIG. 6 is a graph of the FTIR testing (Methacrylic Acid Only) of this same coating program applied to a silicon test wafer.

FIG. 7 is a graph of the FTIR testing (copolymer of MAA and fluoropolymer) of this same coating program applied to a silicon test wafer.

FIG. 8 is a graph of the Distek Dissolution Tester at a constant bath temperature.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention also includes a multifunctional polymer film formed by plasma discharge a multifunctional polymer deposited on a substrate, wherein the multifunctional polymer comprises one or more monomers having one or more reactive functional groups for the subsequent attachment of targeted molecules that reduces adsorptions and provides controllable surface densities of reactive surface entities that attach to receptor molecules. The one or more reactive functional groups contributing the non-fouling properties to the polymer film and include ethylene oxide linkages, di-ethylene glycol vinyl, tri-ethylene glycol vinyl, allyl ethers and/or crown ethers, one or more reactive functional groups comprising —COOH, —NH₂, —CNO, C—Br, —SH, —CClO, —OH, —CHO, —C═O, anhydrides and one or more unsaturated bonds, one or more unsaturated double bonds. In addition to the non-fouling properties the present invention also provides controlled release of coating, reducing adsorption, non-fouling, moisture resistance, attaching receptor molecules, active groups on surface, preventing or controlling movement through media, increased bioavailability, and modifying active-agent release.

The present invention provides a process of forming a multifunctional polymer film by plasma discharge by providing one or more monomers to a plasma discharge reactor, wherein the one or more monomers comprising one or more reactive functional groups for the subsequent attachment of targeted molecules; polymerizing the one or more monomers into a multifunctional polymer; forming a polymer film from the multifunctional polymer on a surface that reduces adsorptions and provides controllable surface densities of reactive surface entities that attach to receptor molecules.

The plasma discharge reactor is a under continuous-wave plasma discharge reactor or a pulsed plasma discharge reactor and can include varying the power input, the pulsed plasma duty cycles to control the relative surface densities of the one or more reactive functional groups.

The one or more reactive functional groups contributing the non-fouling properties to the polymer film and include ethylene oxide linkages, di-ethylene glycol vinyl, tri-ethylene glycol vinyl, allyl ethers and/or crown ethers and COOH, —NH₂, —CNO, C—Br, —SH, —CClO, —OH, —CHO, —C═O, anhydrides. The polymer film includes one or more unsaturated bonds, e.g., one or more unsaturated double bonds. The polymer film further reduces the molecule adsorptions on the polymer film to reduce fouling and minimize the extent of peptide and protein adsorptions.

The polymer may also include an intermediate coupling molecules that attaches biomolecules, e.g., anti-bodies, drugs, anti-microbial agents, labeled compounds, potential sensor molecules, proteins and peptides or combinations thereof. The intermediate coupling molecules that tethers from the polymer film at controllable distances. The plasma synthesized composite films can be applied to any solid substrate.

The monomers selected for this initial study, to demonstrate the efficacy of this process, were vinyl acetic acid (VAA) and diethylene glycol vinyl ether (EO2V). It has been previously demonstrated that plasma polymerization of the EO2V monomer provides surface ethylene oxide (EO) groups, which are extremely effective in minimizing non-specific biomolecule adsorptions.^{[8]} The VAA is employed to introduce reactive —COOH groups, which are then subsequently used to attach target molecules, in this case an antibody, to the plasma modified surfaces. As documented below, it is possible to vary, in highly controlled fashion, the relative surface densities of these two functional groups. Quantification of the surface chemical composition controllability was obtained using spectroscopic surface analyses, water wettability and direct measurement of the relative extents of covalent attachment of a specific protein, compared to non-specific protein adsorption, on these molecularly tailored surfaces. It is important to note that the process described is quite general in scope in that it can be readily applied to virtually any surface in that the gas phase surface modification process is completely conformal in nature. Applications of this technology include coating of fine particles, even nanosized substrates, as demonstrated in our lab. Additionally, it can be employed to introduce a wide variety of reactive surface groups for subsequent attachment of receptors, dependent simply on the choice of functionalized monomer employed, thus providing a plethora of options for the subsequent attachment of targeted molecules to the plasma modified surfaces.

The plasma depositions were carried out in a reactor, e.g., a conical reactor. Radio frequency power input of 2-25 MHz (e.g., 13.56 MHz), was employed to create the plasma discharge. Separate monomer inlets, each controlled by a fine metering valve, were used to regulate the partial pressure of the two monomers. A pulsed plasma, in lieu of the more conventional continuous wave operational mode, was employed in this study, although it is recognized that the results should be achievable using continuous-wave plasmas. As shown in numerous prior studies, the pulsed mode provides a favorable route to retention of monomer functional groups in the polymer films created while, at the same time, providing excellent adhesion of the films to the underlying solid substrate. In particular, a relatively high power input plasma discharge is first employed to strongly graft the initially formed films to the substrate. Once this has been accomplished, the pulsed plasma duty cycle is slowly decreased, during which time the retention of monomer functionalities in the film is progressively increased. The films were deposited on a variety of solid substrates which included polished silicon, glass, and various polymer substrates. Additionally, KBr discs were employed for the FT-IR studies.

### Example 1

After substrates were placed inside the reactor, a background pressure of 5 mtorr was achieved. Oxygen plasma, at a 100 W average power input, was employed to remove any carbonaceous residue left on the substrates. Monomer vapor was introduced into the reactor chamber and an RF glow discharge was maintained at 80 mtorr. Samples were prepared using pure VAA and EO2V. The VAA sample was prepared using plasma on and off times of 0.75 and 20 ms, peak power 200 W; whereas, the EO2V samples were produced at on:off ratios of 1/50 (ms), peak power 37 W (Table 1).

TABLE 1
Plasma parameters for films deposition and films name.

| Sample | Plasma | | Pressure (mTorr) | | |
|---|---|---|---|---|---|
| Name | Power (W) | Duty Cycle | EO2V | VAA | Total |
| EO2V | 37 | 1/50 | 60 | — | 80 |
| E/V1 | 200 | 0.1/30 | 60 | 20 | 80 |
| E/V2 | 150 | 0.1/30 | 60 | 20 | 80 |
| E/V3 | 100 | 0.1/30 | 60 | 20 | 80 |
| VAA | 200 | 0.75/20 | — | 80 | 80 |

Additionally, samples were prepared from the mixed monomers, in which the partial pressures of the EO2V and VAA were 60 and 20 mtorr, respectively. In these runs, the peak plasma power input was varied from 200 to 150 to 100 W and on:off ratios of 0.1/30 ms. The mixed monomer samples are identified as E/V1, E/V2 and E/V3 for the depositions involving pesak powers of 200, 150 and 100 W, as identified in Table 1. Samples prepared under all of these conditions exhibited excellent stability with respect to long term exposure to aqueous buffer solutions.

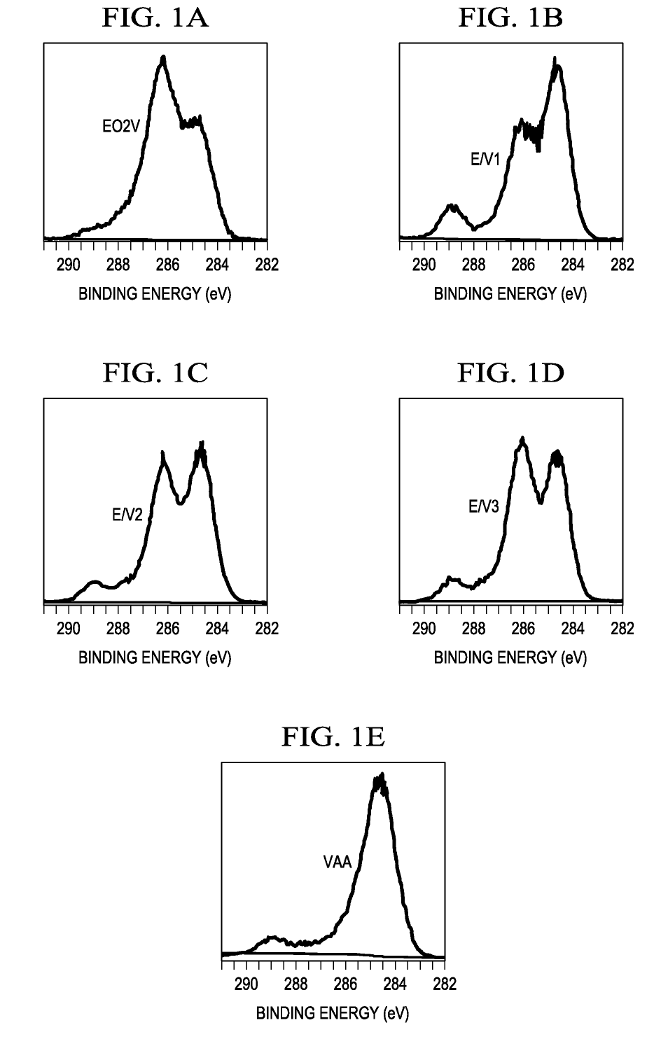

These samples were then characterized as to composition using various techniques. The methods employed included X-Ray Photoelectron Spectroscopy (XPS), Fourier Transform-Infrared Spectroscopy (FT-IR) and sessile drop contact angle goniometry. All of these analyses confirmed the excellent, high level of film chemistry controllability achieved during the plasma depositions, as documented in FIGS. 1, 2, and 3.

FIGS. 1A-1E are graphs of a high resolution C(1s) XPS spectra for films EO2V (FIG. 1A), E/V1 (FIG. 1B), E/V2 (FIG. 1C), E/V3 (FIG. 1D) and VAA (FIG. 1E). In FIG. 1, the high resolution C (1s) XPS spectra are presented for films obtained from each of the pure monomers (labeled EO2V and VAA) plus 3 mixed monomer samples (labeled E/V1, E/V2 and E/V3, as identified in Table 1.). The mixed monomer samples were all obtained using an EO2V/VAA ratio of 3/1, at peak powers of 200, 150 and 100 W for samples E/V 1, 2 and 3 respectively. Perusal of these spectra reveal the progressive variation in film composition in the sequence EO2V, E/V1, E/V2, E/V3 and VAA. For example, the large scale changes in the relative peak intensities of the C(1s) photoelectrons, at binding energies of 284.6 eV (carbon atoms not bonded to O atoms) and 286.3 eV (carbon atoms singly bonded to oxygen) shown in the XPS spectra, provide an excellent measure of the progressive changes in film chemistry.^{[9]} In the pure EO2V film, the 286.3 eV peak from the C—O groups clearly dominates over the C—C peak, as expected from the fact that the ratio of C—O to C—C carbons atoms in the starting monomer is 5 to 1. However, the relative intensity of these two peaks change, in sequential fashion, as one scans these spectra from top to bottom, ending with the film from pure VAA which exhibits relatively little C—O content. Also notable in these spectra are the high binding energy C(1s) photoelectron peaks at 289 eV which arise from the presence of carboxylic (COO) groups, present either as the acid (COOH) or the ester (COOC) entities.^{[9]}

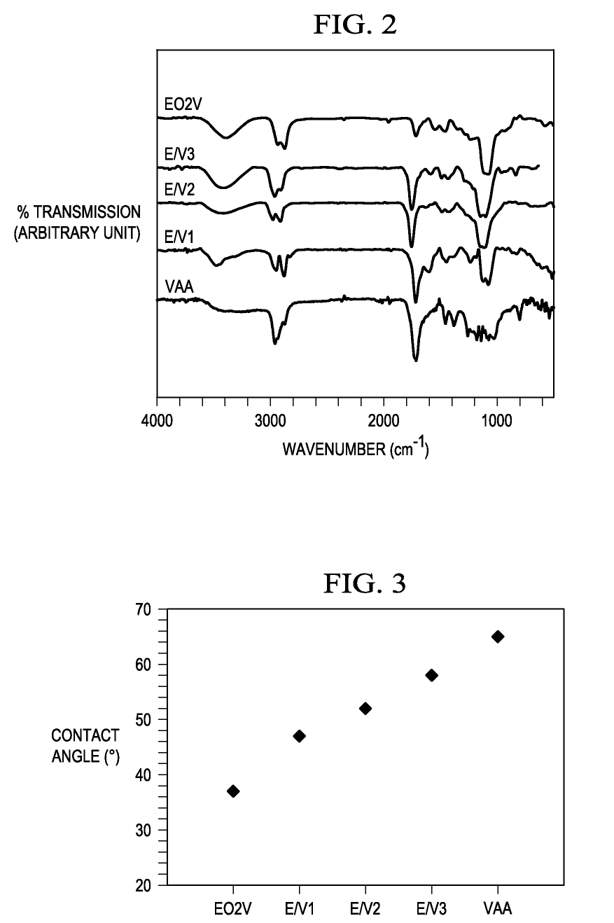

FIG. 2 is a is a graph of the FTIR spectra for films EO2V, E/V1, E/V2, E/V3 and VAA. FT-IR spectra of these same five samples provide further confirmation of the sequential changes in the composition of these films, as shown in FIG. 2. Particularly significant are the progressive relatively decreased intensities of the IR absorption bands at ˜3400 cm⁻¹ and 1100 cm⁻¹, corresponding to O—H and C—O stretching vibrations respectively, in transitioning from pure EO2V, through the composite films to pure VAA.^{[10]} The top spectrum shows the distinct presence of —OH and CO vibrations, reflecting the presence of an OH group and COC bonds from the ethylene oxide groups in the starting monomer, as well as C—OH vibrations. However, the prominence of both peaks become progressively decreased, relative to other absorption bands, in the composite films and the carbonyl absorption (˜1780 cm⁻¹) is progressively more pronounced in going from E/V1 to E/V3. The decrease in the relatively sharp O—H band is gradually replaced with a much broader band covering the range from 3600 to 3000 cm⁻¹. This very broad absorption band is characteristic of O—H absorptions specifically from carboxylic groups.^{[10]} Both the relatively sharp OH and COC stretch vibrations are essentially absent in the film from pure VAA, which is consistent with the structure of this compound. It is noted that a small carbonyl absorption is observed in the pure EO2V film, despite the fact this functional group is not present in the starting monomer. However, the generation of new functional groups is not an unusual occurrence for plasma generated films, as created by the energetic conditions prevalent in these polymerizations during the plasma on periods.^{[11]} With respect to the carbonyl absorptions observed in the various films, the peak absorption shifts slowly from around 1755 cm⁻¹ to 1720 cm⁻¹ in going from top to bottom of these spectra. This shift to lower wavenumbers is consistent with that expected from increased involvement of the C═O group with H-bond formation in these films as shown by the broad absorption bands in the 3600 to 3000 cm⁻¹ region.^{[10]}

FIG. 3 is a graph of the contact angle for films EO2V, E/V1, E/V2, E/V3 and VAA. Sessile drop water contact angles for each of these films were determined and the results are shown in FIG. 3. As shown in this figure, the water contact angle becomes progressively higher over the same film sequence shown above, namely EO2V<E/V1<E/V2<E/V3<VAA. This variation, in surface energies, is certainly in accord with expectations based on monomer structures and the XPX and FT-IR results. The EO2V monomer contains more polar groups than the VAA and thus film wettability should decrease as the relative EO and OH content in the films is decreased. As in the case of the spectroscopic results, it is significant to note that the water contact angle measurements provide added valuable support for the relatively smooth and progressive transition in film composition achievable using this simple PECV approach.

Thus, all of the XPS, FT-IR and water contact angle experimental are in accord in showing that it is possible via this mixed monomer approach to control the relative surface densities of the non-fouling and reactive sites in a highly controlled fashion using this plasma deposition process.

### Example 2

The objective behind creation of the chemical compositional controllability illustrated in Example 1 was to demonstrate the utility of these surfaces in controlling non-specific biomolecule adsorptions, but, at the same time, permit attachment of specific target molecules to these surfaces. For this purpose, fluorescently labeled antibodies were covalently attached to the EO2V, E/V1, E/V2, E/V3 and VAA surfaces, described in Example 1. Goat anti-rabbit IgG antibodies, containing the Alexa 488 fluorescent functionality, were employed for this purpose. These antibodies were attached to the —COOH surface groups via conventional EDC/NHS coupling chemistry.^{[12]} In this coupling reaction, amine groups from the antibody are covalently coupled to the carboxyl groups on the plasma modified surfaces.

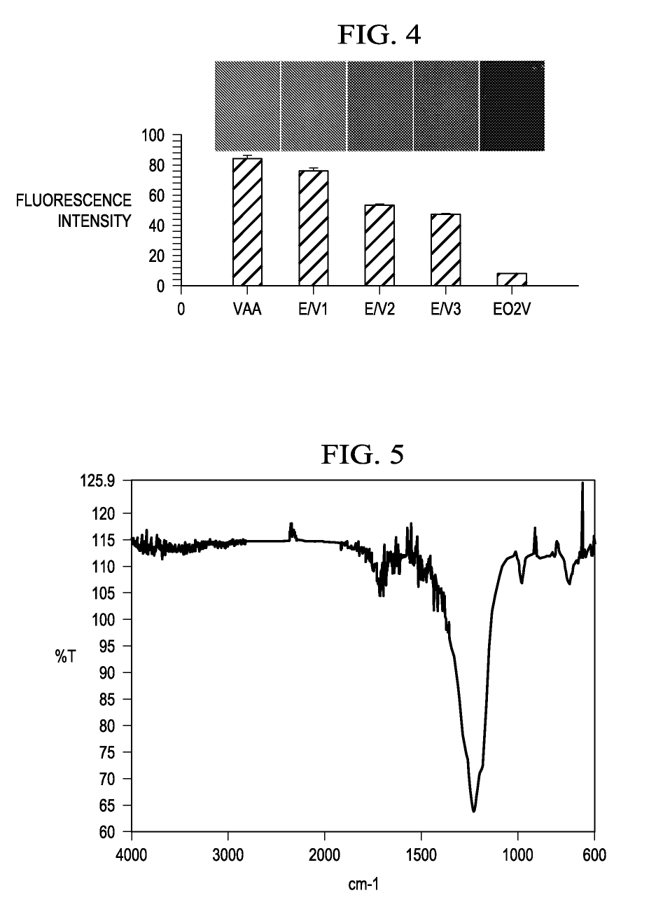

FIG. 4 is a is a graph of the relative fluorescence intensity of the bifunctional surfaces having progressively higher EO content in reading from left to right. The fluorescence emission intensity of these 5 samples were then determined, using an excitation wavelength of 495 nm and monitoring the fluorescence emissions at 519 nm. An example of the results obtained are shown in FIG. 4. Clearly, a progressive increase in the relative fluorescence intensity of these samples is observed in the transition from pure EO2V, through the composite films, to the pure VAA. The extent of fluorescence variation is far greater than the differences in carboxyl content of the VAA, E/V1, E/V2 and E/V3 films, as shown by the XPS results, such as that shown in FIG. 4. In fact, the carboxyl content of these films, with the exception of the one from pure EO2V, is roughly constant. What is very different for these films is the dramatic increase in the EO film content in this progression, in samples arranged from left to right, in FIG. 4. These results, very clearly indicate a substantial decrease in non-specific antibody adsorption through the sequence VAA, E/V1, E/V2, E/V3 and EO2V. The extremely low fluorescence of the pure EO2V is further confirmation of the effectiveness of the plasma deposited EO groups in preventing biomolecule adsorptions. ^{[8]} In fact, the small fluorescence observed with the EO2V sample is probably the result of the presence of very small amounts of —COOH groups, created during the plasma polymerization of the pure EO2V. For example, deconvolution and integration of the C(1s) high resolution XPS spectra revealed that the —COOH film content of the pure EO2V sample is approximately 15% that of the other samples, when expressed in terms of total carbon atom surface content.

### Example 3

The process described in Example 1 was basically repeated, but this time a monomer mixture of ethylene diamine (EDA) and EO2V was employed during the plasma deposition. The EDA was employed, in lieu of the VAA, so that amine groups could be co-deposited with the EO groups obtained from the EO2V monomer. As in the prior example, XPS, FT-IR and water contact angle measurements were made to confirm the controlled film chemistry attainable during plasma polymerization of the mixed monomers. Subsequently, the amine groups introduced were employed to attach a fluorescently labeled protein, albumin, to these surfaces, using the same EDC/NHS chemistry as employed in Example 1. In this latter case, the carboxyl groups of the protein are coupled covalently to the amine groups deposited on the plasma modified substrates. Fluorescence measurements again confirmed the attachment of the biomolecule to the surfaces in inverse proportion to the surface density of the EO groups deposited from the EO2V monomer during the plasma polymerization steps.

### Example 4

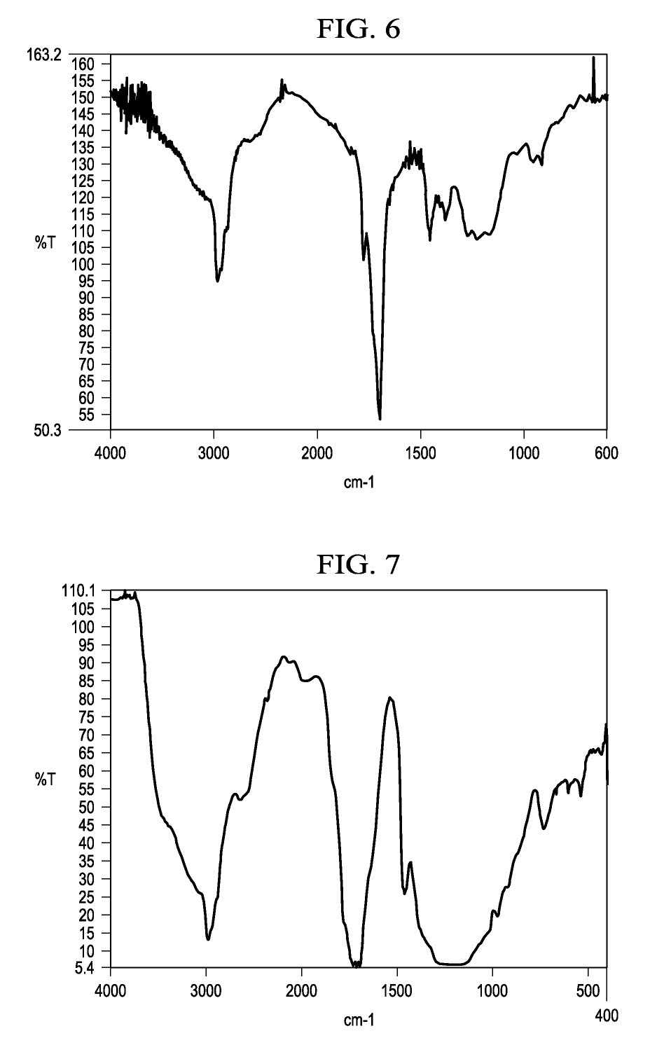

The present invention provides plasma enhanced chemical vapor deposition (PECVD) process was employed using the monomers C₉F₁₈ and methacrylic acid (MAA) to deposit a controlled release coating on the surface of a BSA and an enteric excipient blended particle. The blended particles were prepared by first co-dissolving BSA and an enteric excipient in water at a weight ratio of 95 to 5. In addition, the co-dissolving BSA and an enteric excipient in water at a weight ratio of 95 to 5 to 50 to 50, e.g., 95:5, 90:10, 85:15, 80:10, 75:25, 70:30, 65:35, 60:40, 55:45, and 50:50. After co-dissolving the resultant mixture was then frozen and lyophilized to obtain a final blended particle powder. These particles were then coated using the PECVD process to obtain three separate coated samples. The first sample was coated with only C₉F₁₈ monomer using a 13.56 MHz plasma with a peak power of 75 watts and a duty cycle of 1 ms on and 3 ms off. The reactor chamber was maintained at a pressure of 105 mTorr with a monomer flow rate of 50 sccm. FTIR testing of this same coating program applied to a silicon test wafer is shown in FIG. 5. From FIG. 5 it is clear that a large amount of fluorocarbon material has been deposited on the substrate as evidenced by the absorption peak located at approximately 1220 cm⁻¹ which is representative of the CF functional group. The second sample was coated with only MAA monomer using a 13.56 MHz plasma with a peak power of 150 watts and a duty cycle of 1 ms on and 3 ms off. The reactor chamber was allowed to operate at maximal monomer flow rate, not measured, which resulted in a chamber pressure of 400 mTorr during the PECVD process. FTIR testing of this same coating program applied to a silicon test wafer is shown in FIG. 6. From FIG. 6 it is clear that a large amount of material containing carboxylic acid functionality has been deposited on the substrate as evidenced by the absorption peak located at 1700 cm⁻¹ and the broad band absorption from 3500-2200 cm⁻¹ which are representative of the C═O and OH functional groups, respectively. Finally the third sample was coated with a combination of C₉F₁₈ and MAA monomers applied simultaneously using a 13.56 MHz plasma with a peak power of 75 watts and a duty cycle of 1 ms on and 3 ms off. The reactor chamber was maintained at a pressure of 200 mTorr with a C₉F₁₈ monomer flow rate of 50 sccm and maximal flow rate of MAA, which was not measured. FTIR testing of this same coating program applied to a silicon test wafer is shown in FIG. 7. From FIG. 7 it is clear that a large amount of material containing both fluorocarbon and carboxylic acid functionality were deposited on the substrate as evidenced by the absorption peaks located at 1220 cm⁻¹, 1700 cm⁻¹, and 3500-2200 cm⁻¹ which are representative of CF, C═O, and OH functional groups, respectively.

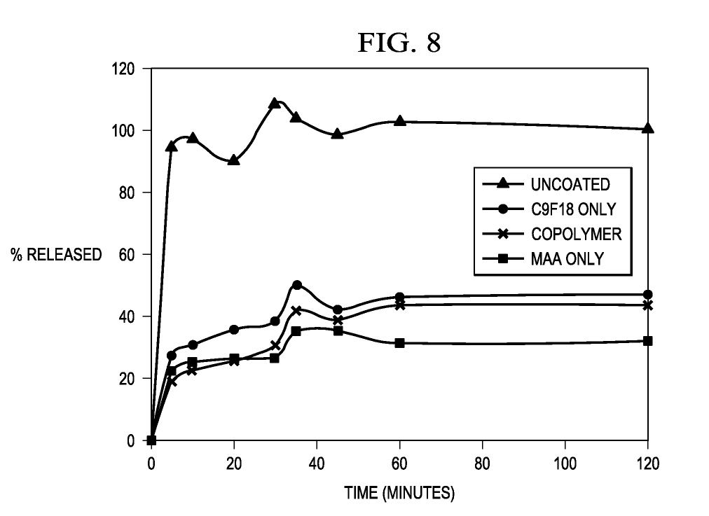

These samples as well as an uncoated control were then tested using a Distek dissolution apparatus to determine the effect of the coating on the dissolution behavior of the coated materials. Dissolution testing was preformed according to USP 29 Apparatus 2 guidelines (paddle method) at 50 rpm in a Distek Dissolution Tester at a constant bath temperature of 37.0+/−0.2° C. The results of this testing are shown in FIG. 8. From this graph it is clear that the simultaneous deposition of a combined gaseous mixture of monomers, in this case C₉F₁₈ and MAA, resulted in a coating with properties which are unique and different from the properties of either coating monomer alone. This technique can therefore allow for the development of novel properties that might not be obtainable with the utilization of only an individual monomer in the PECVD process.

The surface used for polymer deposition in the present invention may be any surface and in particular medical devices. Medical devices may be implanted either permanently or temporarily and may be of the type used through the body from a heart, to a hip, to a stint or medical screw.

Polymers that are suitable for use as the present invention include polyesters, polycarbonates, co-polymers of styrene and mixtures thereof. Examples of preferred matrix polymers are acrylonitrile-butadiene-styrene terpolymer (ABS); ABS modified polyvinylchloride; ABS-polycarbonate blends; acrylic resins and co-polymers: poly(methacrylate), poly(ethylmethacrylate), poly(methylmethacrylate), methylmethacrylate or ethylmethacrylate copolymers with other unsaturated monomers; casein; cellulosic polymers: ethyl cellulose, cellulose acetate, cellulose acetatebutyrate; ethyl vinyl acetate polymers and copolymers; poly(ethylene glycol); poly(vinylpyrrolidone); acetylated mono-, di-glycerides and tri-glycerides; poly(phosphazene); chlorinated natural rubber; polybutadiene; polyurethane; vinylidene chloride polymers and copolymers; styrene-butadiene copolymers; styrene-acrylic copolymers; alkylvinylether polymers and copolymers; cellulose acetate phthalates; epoxies; ethylene copolymers: ethylene-vinyl acetate-methacrylic acid, ethylene-acrylic acid copolymers; methylpentene polymers; modified phenylene oxides; polyamides; melamine formaldehydes; phenolformaldehydes; phenolic resins; poly(orthoesters); poly(cyanoacrylates); polydioxanone; polycarbonates; polyesters; polystyrene; polystyrene copolymers: poly(styrene-co maleic anhydride); urea-formaldehyde; urethanes; vinyl resins: vinyl chloride-vinyl acetate copolymers, polyvinyl chloride and mixtures of two or more of these.

In addition, the one or more reactive functional groups may be biomolecules (e.g., DNA, proteins, and peptides) pharmaceutical active agents and nonpharamacutical agents (e.g., vitamins, minerals and the like). The functional groups on the polymer can be nutraceuticals, allergens, botanicals, enzymes, proteins, peptides, carbonaceous compounds, nucleic acids, vitamins, minerals, elemental molecules, fatty acids, lipids, photolabile compounds, food, cosmetics, or dyes, as examples. Agents can be used in various combinations. Active pharmaceuticals ingredients Active Pharmaceutical Ingredients (APIs) may include analgesic anti-inflammatory agents such as, acetaminophen, aspirin, salicylic acid, methyl salicylate, choline salicylate, glycol salicylate, 1-menthol, camphor, mefenamic acid, fluphenamic acid, indomethacin, diclofenac, alclofenac, ibuprofen, ketoprofen, naproxene, pranoprofen, fenoprofen, sulindac, fenbufen, clidanac, flurbiprofen, indoprofen, protizidic acid, fentiazac, tolmetin, tiaprofenic acid, bendazac, bufexamac, piroxicam, phenylbutazone, oxyphenbutazone, clofezone, pentazocine, mepirizole, and the like.

Antimicrobial agents including antibacterial agents, antifungal agents, antimycotic agents and antiviral agents; tetracyclines such as, oxytetracycline, penicillins, such as, ampicillin, cephalosporins such as, cefalotin, aminoglycosides, such as, kanamycin, macrolides such as, erythromycin, chloramphenicol, iodides, nitrofrantoin, nystatin, amphotericin, fradiomycin, sulfonamides, purrolnitrin, clotrimazole, itraconazole, miconazole chloramphenicol, sulfacetamide, sulfamethazine, sulfadiazine, sulfamerazine, sulfamethizole and sulfisoxazole; antivirals, including idoxuridine; clarithromycin; and other anti-infectives including nitrofurazone, and the like. Other agents include organophosphates, organochlorines, biological insecticides, antifeedants, pyrethroids, carbamates, neonicotinoids, fungicides, anilines, aromatic acids, arsenicals, phenoxyaliphatic acid, benzoic acids, picolinic acids (pyridines) and relatives, amino acid inhibitors such as glyphosate and sulfosate, imidazolinones, ureas, sulfonylureas, sulfonanilides, chlorophyll/carotenoid pigment inhibitors, lipid biosynthesis inhibitors, bipyridyliums, diphenyl ethers (nitrophenyl ethers), glufosinates, azoles, triazines, triazoles, triazolones, triazolinons, dinitroanilines (dinitrobenzenamines), substituted amides (chloroacetamides), thiocarbamates (carbamothioates), bensulide, napropamide, pronamide, dichlobenil, dithiopyr, strobilurins, tebuconazole, metribuzin, and sulfenatrazone.

Cholinergic agonists such as, choline, acetylcholine, methacholine, carbachol, bethanechol, pilocarpine, muscarine, arecoline, and the like. Antimuscarinic or muscarinic cholinergic blocking agents such as, atropine, scopolamine, homatropine, methscopolamine, homatropine methylbromide, methantheline, cyclopentolate, tropicamide, propantheline, anisotropine, dicyclomine, eucatropine, and the like.

In one aspect of the present invention, coating materials such as perfluorohexane (C₆F₁₄), methyl methacrylate (MMA), and methacrylic acid (MAA) are provided. Coatings or polymer films obtained by plasma polymerization of methacrylic acid and methyl methacrylate are hydrophilic. Coatings or polymer films obtained by plasma polymerization of perfluorohexane are hydrophobic. Chemical structures of (a) perfluorohexane, (b) methyl methacrylate, and (c) methacrylic acid are shown below.

Perfluorocarbon compounds, such as perfluorohexane, yield plasma polymerized fluorinated films that exhibit good adhesion to many organic and inorganic substrates, have low intermolecular forces, low friction coefficient, and are biocompatible. The present inventors have previously shown that a pulsed plasma polymerization process may be used with perfluorocarbon compounds to create polymers and polymers films. (See U.S. Pat. No. 5,876,753; U.S. Pat. No. 6,306,506; U.S. Pat. No. 6,214,423; all of which are herein incorporated by reference). Polymers of hexafluoro-propylene oxide (C₃F₆O), perfluoro-2-butyltetrahydrofuran (PF₂BTHF, C₈F₁₆O) and perfluoropropylene (C₃F₆) create excellent coatings or films that are capable of attaching to substrate surfaces. Siloxane compounds, such as Hexamethyldisiloxane (HMDSO), also yield plasma polymerized films that exhibit good adhesion to many organic and inorganic substrates, have low intermolecular forces, low friction coefficient, hydrophobic behavior, and are biocompatible.

Antimicrobial agents including antibacterial agents, antifungal agents, antimycotic agents and antiviral agents; tetracyclines such as, oxytetracycline, penicillins, such as, ampicillin, cephalosporins such as, cefalotin, aminoglycosides, such as, kanamycin, macrolides such as, erythromycin, chloramphenicol, iodides, nitrofrantoin, nystatin, amphotericin, fradiomycin, sulfonamides, purrolnitrin, clotrimazole, itraconazole, miconazole chloramphenicol, sulfacetamide, sulfamethazine, sulfadiazine, sulfamerazine, sulfamethizole and sulfisoxazole; antivirals, including idoxuridine; clarithromycin; and other anti-infectives including nitrofurazone, and the like.

Plasma Enhanced Chemical Vapor Depositions PECVD provides for a solventless, pin-hole free, single-step encapsulation process in which the encapsulating or coating material may be modified depending on the process, itself. For example, the process is able to control encapsulation, and hence, particle introduction into an environment, by adjusting the side groups, thickness, wettability, molecular weight, cross-linking density, surface area and/or composition of the coating material.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

[1] Y. Wang, J. Dostalek, W. Knoll, Biosens. Bioelectron., 2009, 24, 2264.
[2] M. Mir, M. Alvarez, O. Azzaroni, W. Knoll, Langmuir, 2008, 24, 13001.
[3] M. Mir, O. Azzaroni, M. Alvarez, W. Knoll, Talanta, 2009, 78, 1102.
[4] F. Shen, J. Genzer, O. J. Rojas, P. V. Gurgel, R. G. Carb237th ACS National Meeting, March, 2009.
[5] K. V. Gobi, H. Iwasaka, N. Miura, Biosen. Bioelectron., 2007, 22, 1382.
[6] S. Chen, A. R. G. Wylie, A. Douglas, C. T. Elliot, Talanta, 2008, 76, 832.
[7] H. Chen, L. Yuan, W. Song, Z. Wu, D. Li, Progress Poly. Sci., 2008, 33, 1059.
[8] J. Y. Wu, R. B. Timmons, J. S. Jen, F. E. Molock, Colloids and Surfaces, B: Biointerfaces, 2000, 18, 235.
[9] G. Beamson, and D. Briggs. High Resolution XPS of Organic Polymers, Wiley, New York (1992).
[10] G. Socrates, Infrared Characteristic Group Frequencies, 2nd ed.; J. Wiley and Sons: New York, 1994.
[11] H. Yasuda, Plasma Polymerization; Academic Press: Orlando, Fla., 1985.
[12] D. Sehgal, I. K. Vijay, Anal. Biochem. 1994, 218, 87.

What is claimed is:

1. A process of forming a multifunctional polymer film by plasma discharge comprising the steps of:
providing one or more monomers to a plasma discharge reactor, wherein the one or more monomers comprising one or more functional groups;
polymerizing the one or more monomers into a multifunctional polymer; and
forming a polymer film from the multifunctional polymer on a surface.

2. The process of claim 1, wherein the one or more reactive functional groups contribute to the non-fouling properties, moisture resistance, attaching receptor molecules, active group on surface, preventing or controlling movement through media, increased bioavailability, modifying active-agent release, reduce the molecule adsorptions, minimize the extent of peptide and protein adsorptions or a combination thereof of the polymer film.

3. The process of claim 1, wherein the plasma discharge reactor is a under continuous-wave plasma discharge reactor or a pulsed plasma discharge reactor.

4. The process of claim 1, further comprising the step of varying the power input, the pulsed plasma duty cycles to control the relative surface densities of the one or more reactive functional groups.

5. The process of claim 1, wherein the polymer film comprises di-ethylene glycol vinyl, tri-ethylene glycol vinyl, allyl ethers and/or crown ethers.

6. The process of claim 1, wherein the one or more reactive functional groups comprise ethylene oxide linkages —COOH, —NH₂, —CNO, C—Br, —SH, —CClO, —OH, —CHO, —C═O, anhydrides.

7. The process of claim 1, wherein the polymer film comprises one or more unsaturated bonds.

8. The process of claim 1, in which the reactive surface chemical entities present in the plasma synthesized composite films are employed to react with target molecules through chemical reaction, including use of intermediate coupling compounds to attach the target molecules.

9. The process of claim 1, further comprising an intermediate coupling molecule that attaches to biomolecules.

10. The process of claim 1, further comprising an intermediate coupling molecules that attaches anti-bodies, drugs, anti-microbial agents, labeled compounds, potential sensor molecules, or combinations thereof.

11. The process of claim 1, further comprising an intermediate coupling molecule that tethers from the polymer film at controllable distances.

12. The process of claim 1, wherein the surface comprises one or more powders.

13. The process of claim 1, wherein the one or more monomers comprise a bi-functional polymer, a tri-functional polymer or a multiple functional polymer.

14. A process of forming a multifunctional polymer film by plasma discharge comprising the steps of:
providing one or more monomers to a plasma discharge reactor, wherein the one or more monomers comprising one or more reactive functional groups for the subsequent attachment of targeted molecules;
polymerizing the one or more monomers into a multifunctional polymer;
forming a polymer film from the multifunctional polymer on a surface that reduces adsorptions and provides controllable surface densities of reactive surface entities that attach to receptor molecules.

15. The process of claim 14, wherein the one or more monomers comprise a bi-functional polymer, a tri-functional polymer or a multiple functional polymer.

16. The process of claim 14, wherein the polymer film comprises di-ethylene glycol vinyl, tri-ethylene glycol vinyl, allyl ethers and/or crown ethers.

17. The process of claim 14, wherein the one or more reactive functional groups comprise ethylene oxide linkages —COOH, —NH₂, —CNO, C—Br, —SH, —CClO, —OH, —CHO, —C═O, anhydrides.

18. A multifunctional polymer film formed by plasma discharge comprising:
a multifunctional polymer deposited on a substrate, wherein the multifunctional polymer comprises one or more monomers having one or more functional groups for the subsequent attachment of targeted molecules that reduces adsorptions and provides controllable surface densities.

19. The polymer of claim 18, further comprising the step of varying the power input, the pulsed plasma duty cycles to control the relative surface densities of the one or more reactive functional groups.

20. The polymer of claim 18, wherein the polymer film comprises di-ethylene glycol vinyl, tri-ethylene glycol vinyl, allyl ethers and/or crown ethers.

21. The polymer of claim 18, wherein the one or more reactive functional groups comprising ethylene oxide linkages, —COOH, —NH₂, —CNO, C—Br, —SH, —CClO, —OH, —CHO, —C═O, anhydrides.

22. The polymer of claim 18, wherein the polymer film comprises one or more unsaturated bonds.

23. The polymer of claim 18, further comprising an intermediate coupling molecules that attaches biomolecules, selected from anti-bodies, drugs, anti-microbial agents, labeled compounds, potential sensor molecules, or combinations thereof.

24. The polymer of claim 23, further comprising an intermediate coupling molecules that tethers from the polymer film at controllable distances.

25. The polymer of claim 18, wherein the polymer is a bi-functional polymer, a tri-functional polymer or a multi-functional polymer.
